(19) United States
(12) Patent Application Publication
(10) Pub. No.: US 2020/0055723 A1
(43) Pub. Date: Feb. 20, 2020

(54) Spout-Connector And Adaptor For Fluid Dispensing

(71) Applicant: Liqui-Box Corporation, Richmond, VA (US)

(72) Inventor: James W. Johnson, Delaware, OH (US)

(21) Appl. No.: 16/535,496

(22) Filed: Aug. 8, 2019

Related U.S. Application Data
(60) Provisional application No. 62/718,592, filed on Aug. 14, 2018.

(51) Int. Cl. B67D 3/00

(52) U.S. Cl. CPC B67D 3/0035; B67D 3/0067

(57) ABSTRACT

An adapter for dispensing a liquid from a container includes an elongate body having a proximal end and a distal end opposite the proximal end, a probe disposed adjacent to the proximal end, the probe being configured to removably engage with an outlet opening of the container, a valve disposed adjacent to the distal end, and a passage extending through the elongate body, the passage being in fluid communication with the probe and the valve.

### CROSS REFERENCE TO RELATED APPLICATIONS

This application claims the benefit of U.S. Provisional Application No. 62/718,592, filed Aug. 14, 2018, the entirety of which is incorporated herein for any and all purposes.

### TECHNICAL FIELD

This disclosure generally relates to dispensing systems for dispensing liquids, and more particularly relates to dispensing adapters and housings for flexible containers and methods of using the same.

### BACKGROUND

Many systems are used for dispensing liquids from a flexible collapsible bag in in a container. Generally, these systems include a bag that is provided with a fitment in the form of a spout through which filling and dispensing occurs. It is generally desirable to provide a quick-disconnect coupling between the spout and the service line of the pump or other type of beverage mixing and dispensing system. Liquid can be stored in various containers depending on desired storage or dispensing use. Liquid, which includes beverages, can be introduced into a flexible pouch for storage or transportation and then be dispensed from the flexible pouch. A dispensing connector can be attached to the flexible pouch by puncturing a portion of the flexible pouch. There are shortcomings with the conventional dispensing connectors. Sometimes, the flexible pouch can get damaged during filling, transportation, storage, or connection to other dispensing components, such as a dispensing connector. Therefore, there is a need for a dispensing connector assembly that can be utilized with a flexible pouch without damaging the flexible pouch.

### SUMMARY

The foregoing needs are met by the various aspects of dispenser adapters and systems disclosed. According to an aspect of the present disclosure, an adapter for dispensing a liquid from a container, the container having an outlet opening, includes an elongate body having a proximal end and a distal end opposite the proximal end; a probe disposed adjacent to the proximal end, the probe being configured to removably engage with the outlet opening of the container; a valve disposed adjacent to the distal end; and a passage extending through the elongate body, the passage being in fluid communication with the probe and the valve.

The adapter may optionally include a flange extending radially away from the elongate body, the flange being configured to contact a connected component. The adapter may optionally have a flexible elongate body.

According to another aspect, a dispensing system for storing and dispensing a liquid includes a flexible pouch having a dispensing valve, the valve having an open configuration and a closed configuration; an adapter having a probe configured to engage with the dispensing valve; and a rigid container having a receptacle and a spout orifice, the receptacle being configured to receive the flexible pouch and at least part of the adapter. When the valve is in the open configuration, the liquid is permitted to move from the flexible pouch to the adapter, and when the valve is in the closed configuration, the liquid is prevented from passing from the flexible pouch to the adapter.

The adapter may be configured to extend through the orifice of the rigid container. The dispensing system may optionally include a pump coupled to the adapter, the pump being configured to cause the liquid to move from the adapter into and through the pump. The adapter may optionally include an outlet opening and an outlet valve adjacent to the outlet opening, the outlet valve having an open configuration and a closed configuration, wherein when the valve is in in the open configuration, the liquid is permitted to move from the adapter through the outlet opening, and when the valve is in the closed configuration, the liquid is prevented from moving through the outlet opening. The dispensing system may optionally include a cap configured to engage with the dispensing valve on the flexible pouch. The adapter in any of the dispensing systems disclosed may optionally include a probe configured to removable engage with the dispensing valve. The probe may be optionally disposed at an angle relative to the adapter, the angle being between about 0° and about 90°. The probe may optionally include one or more retention members configured to increase friction between the probe and the dispensing valve when the probe is engaged with the dispensing valve. In the one or more dispensing systems disclosed, the at least one of the dispensing valve and the outlet valve may optionally be a duckbill valve.

According to another aspect, a method of assembling a dispensing system includes the steps of providing a rigid container having a receptacle therein and an orifice extending therethrough and being in fluid communication with the receptacle; introducing a flexible pouch containing a liquid into the receptacle; introducing an adapter into the orifice, such that the adapter is at least partly disposed in the receptacle; and engaging the adapter with the flexible pouch, such that a fluid communication is created between the flexible pouch and the adapter.

The flexible pouch may optionally include a dispensing valve, and the method may optionally include the step of removing a cap from the dispensing valve prior to the step of engaging the adapter with the flexible pouch. The method may optionally include connecting a pump to the adapter, the pump being configured to cause the liquid in the adapter to move out of the adapter.

### BRIEF DESCRIPTION OF THE DRAWINGS

The present application is further understood when read in conjunction with the appended drawings. For the purpose of illustrating the subject matter, there are shown in the drawings exemplary aspects of the subject matter; however, the presently disclosed subject matter is not limited to the specific methods, devices, and systems disclosed. In the drawings:

FIG. 1 illustrates an isometric view of an adapter and a dispensing valve with a spout according to an aspect of this disclosure;

FIG. 2 illustrates an isometric cross-sectional view of the adapter and dispensing valve of FIG. 1;

FIG. 3 illustrates a side perspective view of the adapter and dispensing valve of FIGS. 1 and 2;

FIG. 4 illustrates another cross-sectional view of the adapter and dispensing valve of FIGS. 1-3;

FIG. 5 illustrates an exploded view of a dispensing valve and a spout according to an aspect of the present disclosure;

FIG. 6 illustrates an isometric view of a dispensing system according to an aspect of the disclosure;

FIG. 7 illustrates an isometric exploded view of the dispensing system of FIG. 6;

FIG. 8 illustrates a side perspective view of the dispensing system of FIGS. 6 and 7;

FIG. 9 illustrates a cross-sectional view of the dispensing system of FIGS. 6-8;

FIG. 10 illustrates an isometric cross-sectional view of the dispensing system of FIGS. 6-9-8; and

FIG. 11 illustrates an isometric cross-sectional exploded view of the dispensing system of FIGS. 6-10.

Aspects of the disclosure will now be described in detail with reference to the drawings, wherein like reference numbers refer to like elements throughout, unless specified otherwise.

### DETAILED DESCRIPTION OF ILLUSTRATIVE EMBODIMENTS

Liquid can be stored in various containers depending on desired storage or dispensing use. Liquid, which includes beverages, can be introduced into a flexible pouch for storage or transportation and then be dispensed from the flexible pouch. In some scenarios, the flexible pouch is introduced into a rigid container, and the liquid is dispensed from the flexible pouch while in the rigid container. A dispensing connector can be attached to the rigid container and/or the flexible pouch by puncturing a portion of the flexible pouch to fluidly connect the dispensing connector with the interior of the flexible pouch and to allow the liquid to flow therefrom. A need exists for a dispensing connector assembly that can be utilized with a flexible pouch without puncturing the flexible pouch.

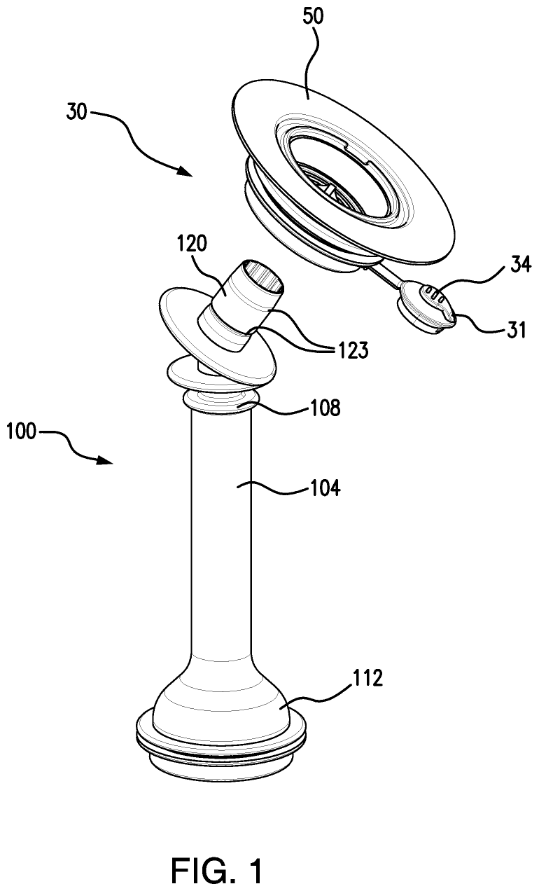

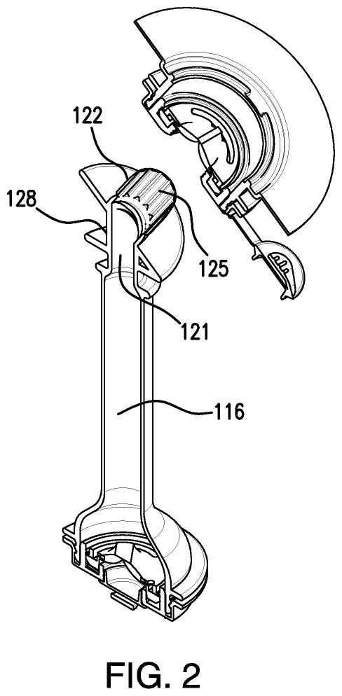

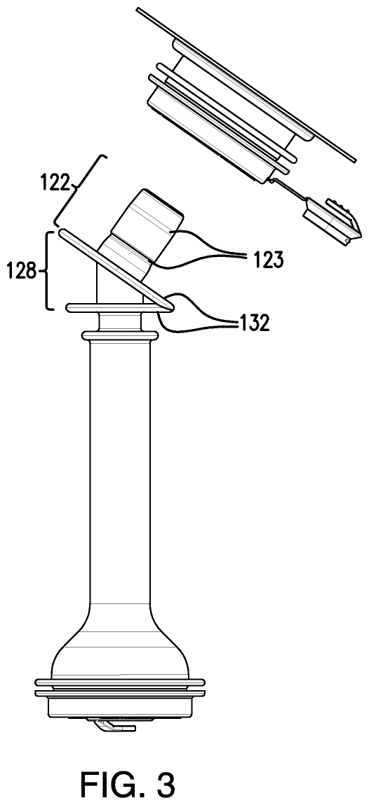

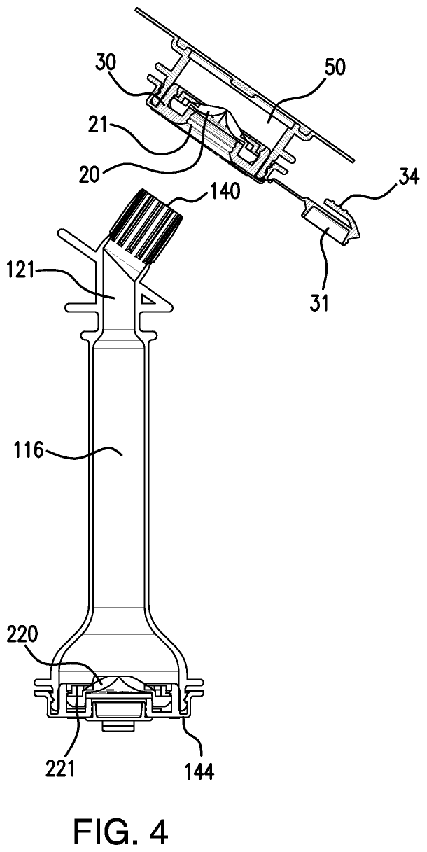

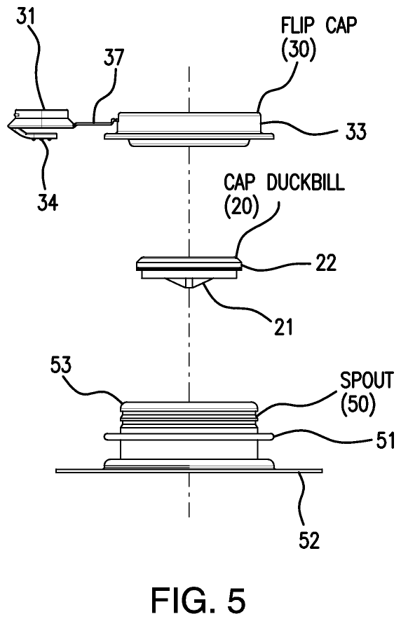

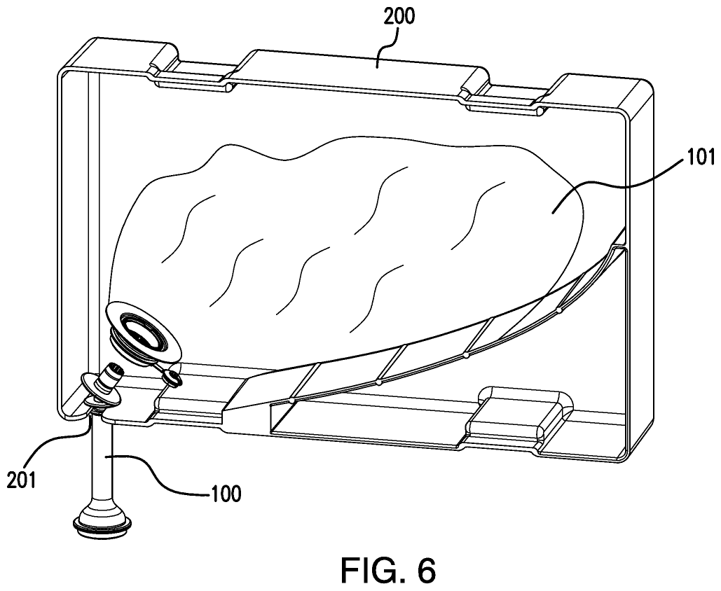

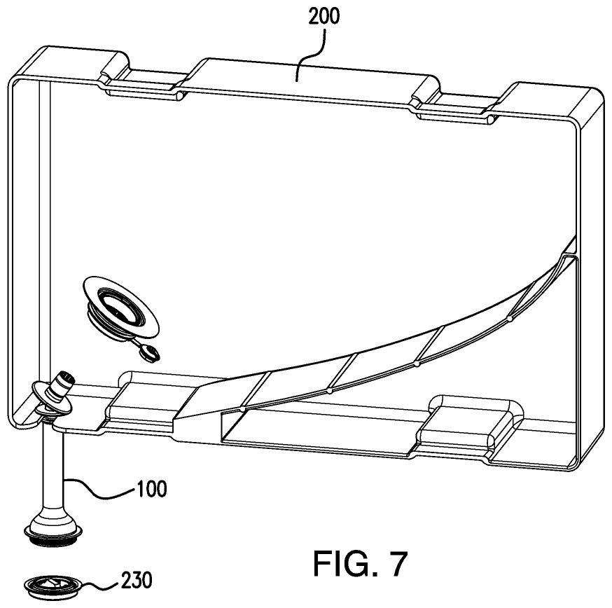

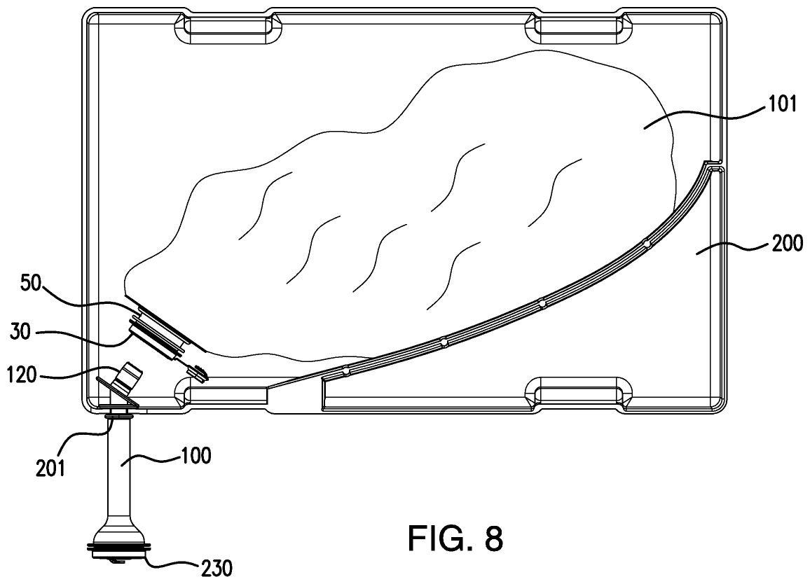

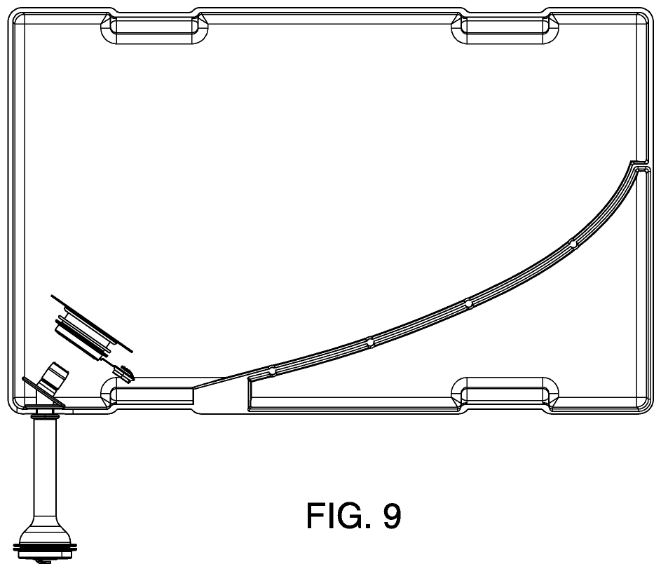

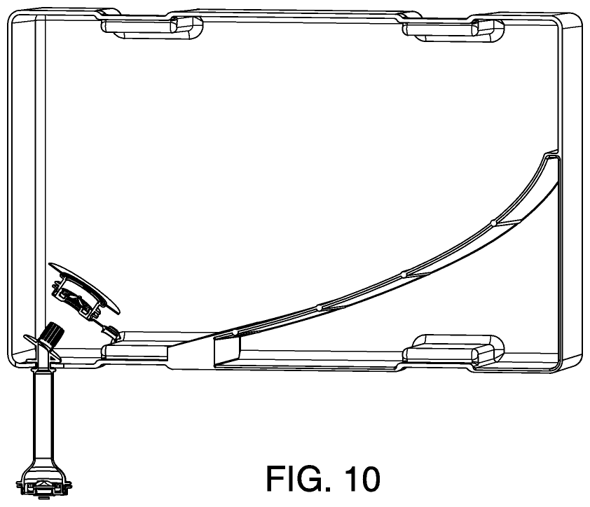

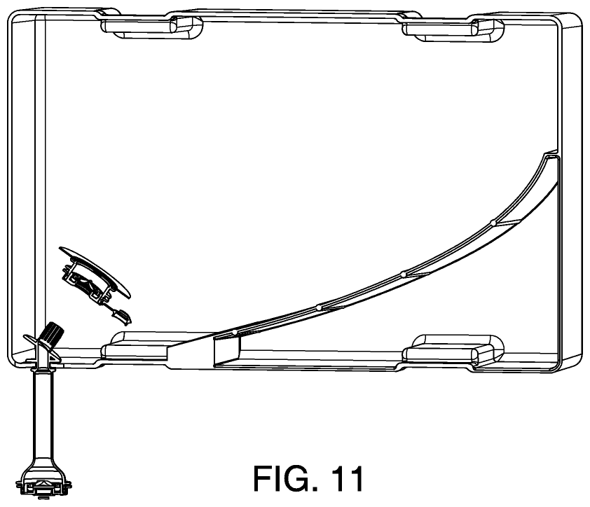

According to FIGS. 1-11, an adapter 100 may be used to removably connect to a flexible pouch 101 such that the adapter 100 fluidly communicates with the interior of the flexible pouch 101 and permits the liquid to flow from inside the flexible pouch 101 into and through the adapter 100. The flexible pouch 101 may be disposed, in part or in whole, within a rigid container 200. The rigid container 200 may include an orifice 201 configured to receive at least a portion of the adapter 100.

The adapter 100 may include an elongate body 104 having a proximal end 108 and a distal end 112 opposite the proximal end 108. The elongate body 104 may be substantially cylindrical, or it may be any other suitable shape, as well as a combination of shapes. It will be understood that the specific shape and dimensions of the elongate body 104 may depend on desired use, the liquid to be dispensed, or on manufacturing standards or preferences. A channel 116 extends through the elongate body 104 between the proximal end 108 and the distal end 112. The elongate body 104 may be rigid, it may be manufactured out of a flexible material, or it may have both a rigid portion and a flexible portion (not shown). The flexible portion may be, for example, accordion-like or a gooseneck. In some aspects, one or more hinges may be present to allow relative rotation of adjacent rigid portions.

A probe 120 may be disposed on or adjacent to the proximal end 108. The probe has an inlet 140 that is in fluid communication with the channel 116 and that is configured to receive the liquid from the flexible pouch 101. The probe 120 may be configured to engage with the flexible pouch 101 or with the rigid container 200. In some aspects, the probe 120 may engage with the outlet opening of the flexible pouch 101. The liquid passes through the probe 120 and into the channel 116 of the elongate body 104.

The probe 120 may comprise plastic. The probe 120 includes a first portion 122 and a second portion 128 adjacent to the first portion 122. One or more flanges 132 may be disposed on the first portion 122, on the second portion 128, or on both portions. In some aspects, the flange 132 may be disposed between the first portion 122 and the second portion 128, such that the two portions are separated from one another by the flange 132. The flanges 132 may be configured to contact one or more surfaces of the rigid container 200 to facilitate keeping the adapter 100 stationary during use. In some aspects, the flanges 132 may contact a spout or dispenser on the flexible pouch 101 to orient the spout or dispenser.

A passage 121 extends from the inlet 140 through the first portion 122 and the second portion 128 and fluidly communicates with the channel 116. The probe 120 may be substantially straight between the inlet 140 and the channel 116. Alternatively, the probe 120 may be bent at one or more portions. In some aspects, the first portion 122 is disposed at an angle to the second portion 128, as shown in FIGS. 1-11. It will be understood that the specific angle between the first and second portions 122, 128 will depend on the flexible pouch 101 to be used, the shape and size of the rigid container 200, the desired orientation of the adapter 100, and/or manufacturing capabilities and preferences. In some aspects, the angle between the first portion 122 and the second portion 128 may be between about 0° and about 90°.

The first portion 122 may include one or more retention members 123 configured to engage with a source of the liquid, a dispensing tube, a spout, or another component typically used in dispensing of liquids. The retention members 123 may include a textured surface, barbs, ridges, notches, adhesives, or other retention mechanisms commonly used in the art.

One or more internal retention members 125 may be disposed on the first portion 122. The internal retention members 125 may be configured to removably engage with a source of the liquid, a dispensing tube, a spout, or another component typically used in dispensing of liquids. The internal retention members 125 may include a textured surface, barbs, ridges, notches, adhesives, or other retention mechanisms commonly used in the art.

In some aspects, the probe 120 may be configured to engage with a dispensing valve 30 disposed on the flexible pouch 101. The liquid in the flexible pouch 101 may pass through the dispensing valve 30 and into the adapter 100.

Referring to FIGS. 1-11, the dispensing valve 30 may include a flip lid 31 with a pull tab 34. The dispensing valve 30 may have an open orientation, in which liquid from the flexible pouch 101 can pass therethrough, and a closed orientation, in which liquid is prevented from passing through the dispensing valve 30. A spout 50 may be attached to the dispensing valve 30, the spout 50 being configured to engage with, either removably or permanently, the outlet opening of the flexible pouch 101 containing the liquid to be dispensed. The dispensing valve 30 includes an opening 21, into which a suitable connector may be introduced. The opening 21 is in fluid communication with the interior of the flexible pouch 101 and can receive the liquid therefrom. In some aspects, the probe 120 of the adapter 100 may be removably inserted into the opening 21, such that the passage 121 of the probe 120 is in fluid communication with the interior of the flexible pouch 101.

A duckbill 20 may be disposed on the dispensing valve 30. The duckbill 20 operates as a regulator and can be in an open position to allow liquid to flow therethrough, or in a closed position to prevent liquid flow. When the dispensing valve 30 is not engaged with a dispensing connector (such as the probe 120), the duckbill 20 remains closed, and the liquid is prevented from passing from the flexible pouch 101 through the dispensing valve 30. Upon engaging with a dispensing connector (such as the probe 120), the duckbill 20 is in an open configuration and permits the liquid inside the flexible pouch 101 to move through the dispensing valve 30 and into the connector. In some aspects, when the probe 120 is inserted into the opening 21 of the dispensing valve 30, the duckbill 20 is opened, and the liquid from inside the flexible pouch 101 is permitted to pass through the dispensing valve 30, into the probe 120, and into the adapter 100.

The liquid may move through the adapter 100 in the direction of the distal end 112 and out of the adapter 100 at an outlet opening 144 disposed at or adjacent to the distal end 112. In some aspects, an outlet valve 230 may be disposed adjacent to the outlet opening 144. The outlet valve 230 may have an open configuration, in which the liquid passing through the channel 116 is permitted to exit the adapter 100, and a closed configuration, in which the liquid is prevented from passing through the outlet opening 144. In some aspects, the outlet valve 230 may be similar in form and functionality as the dispensing valve 30, although it will be understood that a different regulator or valve may be used to control liquid flow out of the adapter 100.

Specifically, in some aspects, the outlet valve 230 may have an open orientation, in which liquid from the channel 116 can pass therethrough, and a closed orientation, in which liquid is prevented from passing through the outlet valve 230. The outlet valve 230 includes an opening 221. The opening 221 is in fluid communication with the channel 116 of the adapter 100 and can receive the liquid therefrom.

A duckbill 220 may be disposed on the outlet valve 230. The duckbill 220 operates as a regulator and can be in an open position to allow liquid to flow therethrough, or in a closed position to prevent liquid flow. The outlet valve 230 may be toggled between the open and closed configurations by a dispensing component being introduced into or removed from the opening 221, respectively. The dispensing component may include a dispensing spout or faucet (not shown). Similarly to how the probe 120 may be inserted into the opening 21 of the dispensing valve 30 to cause the duckbill 20 to transition the dispensing valve 30 into the open configuration, a spout or faucet may be connected to the opening 221 to cause the duckbill 220 of the outlet valve 230 to transition from the closed configuration to the open configuration to permit liquid to flow from the adapter 100 to the connected spout or faucet. As the spout or faucet is removed, the duckbill 220 may be closed such that the outlet valve 230 is in the closed configuration to prevent liquid from passing through the outlet 144 and leaving the adapter 100.

In some aspects, a pump (not shown) may be operatively connected to the adapter 100, such that when the pump is actuated, the outlet valve 230 is transitioned into the open configuration to permit liquid to flow through the outlet 144 of the adapter 100. The pump may be further connected to a spout, faucet, tube, or another dispensing component (not shown). As the pump operates, it may force the liquid from the adapter 100 to move through the outlet valve 230 in the open configuration and into the connected spout, faucet, tube, or another dispensing component. Alternatively, the pump may operate to move the liquid from the adapter 100 to a dispensing destination, such as a storage container or beverage appliance.

When the outlet valve 230 is not engaged with a dispensing connector (such as the pump), the duckbill 220 remains closed, and the liquid is prevented from passing from the adapter 100 through the outlet 144.

It will be understood that the components described throughout this specification can be manufactured out of any suitable material, and that the specific material choices and component dimensions will depend on desired use of the component, the liquid to be dispensed, the environmental properties in which the components are to be used, costs, and other manufacturing concerns or preferences. Suitable materials may include, for example, molded thermoplastic materials, such as a polyolefin. Exemplary suitable materials include, for example, polyethylene, copolymers and terpolymers of polyethylene, polypropylene, copolymers and terpolymers of polypropylene, polybutylene and copolymers and terpolymers thereof, fluorocarbon polymers and copolymers thereof, polyvinyl chloride and copolymers thereof, polyvinylidene chloride and fluorocarbon polymers and copolymers thereof. Thermosetting polymers such as epoxy resins, phenolic resins, melamine resins can also be used for dispersing some substances. In some specific aspects, polyethylene, polypropylene and copolymers and terpolymers thereof are used.

The duckbill 20 may be molded from an elastomeric material or a soft flexible plastic material that can withstand the effects of the fluid being dispensed. Suitable materials include, for example, styrene/butadiene copolymers, butyl rubbers, polysulfide rubbers, polyisoprene, ethylene-propylene terpolymers (EPDM rubber), silicone rubbers, polyurethane rubbers, and the like. A soft flexible plastic material can also be used such a linear low molecular weight polyethylene or copolymers and blends thereof. Other components of the assembly can be molded from any of the above materials, for example, a plastic material, such as high density polyethylene or high density polypropylene.

While systems and methods have been described in connection with the various embodiments of the various figures, it will be appreciated by those skilled in the art that changes could be made to the embodiments without departing from the broad inventive concept thereof. It is understood, therefore, that this disclosure is not limited to the particular embodiments disclosed, and it is intended to cover modifications within the spirit and scope of the present disclosure as defined by the claims.

What is claimed is:

1. An adapter for dispensing a liquid from a container, the container having an outlet opening, the adapter comprising:
an elongate body having a proximal end and a distal end opposite the proximal end;
a probe disposed adjacent to the proximal end, the probe being configured to removably engage with the outlet opening of the container;
a valve disposed adjacent to the distal end; and
a passage extending through the elongate body, the passage being in fluid communication with the probe and the valve.

2. The adapter of claim 1, further comprising a flange extending radially away from the elongate body, the flange being configured to contact a connected component.

3. The adapter of claim 1, wherein the elongate body is flexible.

4. A dispensing system for storing and dispensing a liquid, the dispensing system comprising:
a flexible pouch having a dispensing valve, the valve having an open configuration and a closed configuration;
an adapter having a probe configured to engage with the dispensing valve; and
a rigid container having a receptacle and a spout orifice, the receptacle being configured to receive the flexible pouch and at least part of the adapter,
wherein when the valve is in the open configuration, the liquid is permitted to move from the flexible pouch to the adapter, and wherein when the valve is in the closed configuration, the liquid is prevented from passing from the flexible pouch to the adapter.

5. The dispensing system of claim 4, wherein the adapter is configured to extend through the orifice of the rigid container.

6. The dispensing system of claim 4, further comprising a pump coupled to the adapter, the pump being configured to cause the liquid to move from the adapter into and through the pump.

7. The dispensing system of any of claims 4, wherein the adapter further includes an outlet opening and an outlet valve adjacent to the outlet opening, the outlet valve having an open configuration and a closed configuration,
wherein when the valve is in in the open configuration, the liquid is permitted to move from the adapter through the outlet opening, and when the valve is in the closed configuration, the liquid is prevented from moving through the outlet opening.

8. The dispensing system of any of claims 4, further comprising a cap configured to engage with the dispensing valve on the flexible pouch.

9. The dispensing system of any of claims 4, wherein the adapter further includes a probe configured to removable engage with the dispensing valve.

10. The dispensing system of claim 9, wherein the probe is disposed at an angle relative to the adapter, the angle being between about 0° and about 90°.

11. The dispensing system of claim 9, wherein the probe includes one or more retention members configured to increase friction between the probe and the dispensing valve when the probe is engaged with the dispensing valve.

12. The dispensing system of any of claims 4, wherein at least one of the dispensing valve and the outlet valve is a duckbill valve.

13. A method of assembling a dispensing system, the method comprising:
providing a rigid container having a receptacle therein and an orifice extending therethrough and being in fluid communication with the receptacle;
introducing a flexible pouch containing a liquid into the receptacle;
introducing an adapter into the orifice, such that the adapter is at least partly disposed in the receptacle; and
engaging the adapter with the flexible pouch, such that a fluid communication is created between the flexible pouch and the adapter.

14. The method of claim 13, wherein the flexible pouch includes a dispensing valve, the method further comprising removing a cap from the dispensing valve prior to the step of engaging the adapter with the flexible pouch.

15. The method of claim 13, further comprising connecting a pump to the adapter, the pump being configured to cause the liquid in the adapter to move out of the adapter.
